(19) United States
(12) Patent Application Publication
(10) Pub. No.: US 2007/0228084 A1
(43) Pub. Date: Oct. 4, 2007

(54) Cylindrical container

(76) Inventor: I-Feng Wang, Tainan City (TW)

Correspondence Address: OSTROLENK FABER GERB & SOFFEN, 1180 AVENUE OF THE AMERICAS, NEW YORK, NY, 100368403, US

(21) Appl. No.: 11/479,529

(22) Filed: Jun. 30, 2006

(30) Foreign Application Priority Data
Apr. 3, 2006 (TW) 095205575

(51) Int. Cl. B67D 3/00

(52) U.S. Cl. 222/522

(57) ABSTRACT

A container includes: a container body defining an inner space; a cap mounted securely on the container body and including an annular inner wall having an inner surface that defines a fluid passage for fluid communication with the inner space, and a seat secured to the annular inner wall and extending into the fluid passage; a valve including a sealing member disposed in the fluid passage and disposed above and seated on the seat; and an operating unit including a pressing member that is disposed in the fluid passage and that is disposed above and that abuts against the sealing member. The sealing member is deformable so as to be deformed to contact sealingly the inner surface of the annular inner wall by pressing action of the pressing member when the operating unit is moved from a first axial position to a second axial position.

### BACKGROUND OF THE INVENTION

1. Field of the Invention

The invention relates to a cylindrical container, more particularly to a cylindrical container having a cap with a valve and an operating unit for controlling opening and closing of the valve.

2. Description of the Related Art

Conventional cylindrical containers, such as a thermos, are normally provided with a control device on a cap thereof for controlling opening and closing of a valve inside a fluid passage in the cap. The control device includes a pressable button that opens the valve when pressed.

### SUMMARY OF THE INVENTION

The object of the present invention is to provide a container including a valve and an operating unit that is rotatable for opening the valve.

Accordingly, a container of the present invention comprises: a container body defining an inner space and having a top open end; a cap mounted securely on the top open end of the container body and including an annular inner wall having an inner surface that defines a fluid passage for fluid communication with the inner space, and a seat secured to the annular inner wall and extending into the fluid passage; a valve including a sealing member disposed in the fluid passage and disposed above and seated on the seat; and an operating unit including a handle that is disposed on an exterior of the cap, and a pressing member that is coupled to the handle, that is disposed in the fluid passage, and that is disposed above and that abuts against the sealing member. The operating unit is operable to move axially relative to the cap between first and second axial positions. The sealing member is deformable so as to be deformed to contact sealingly the inner surface of the annular inner wall by the pressing action of pressing member when the operating unit is moved from the first axial position to the second axial position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a container according to the present invention;

FIG. 2 is a fragmentary exploded perspective view of the preferred embodiment;

FIG. 3 is a fragmentary exploded sectional view of the preferred embodiment;

FIG. 4 is a fragmentary exploded schematic view of the preferred embodiment;

FIG. 5 is a schematic view to illustrate how a driving face of a tubular driving member slides along a cam face of a tubular supporting member of the preferred embodiment;

FIG. 6 is a fragmentary assembled sectional view of the preferred embodiment, illustrating a state where the operating unit is disposed at a first axial position; and

FIG. 7 is a fragmentary assembled sectional view, illustrating another state where the operating unit is disposed at a second axial position.

### DETAILED DESCRIPTION OF THE PREFERRED EMBODIMENT

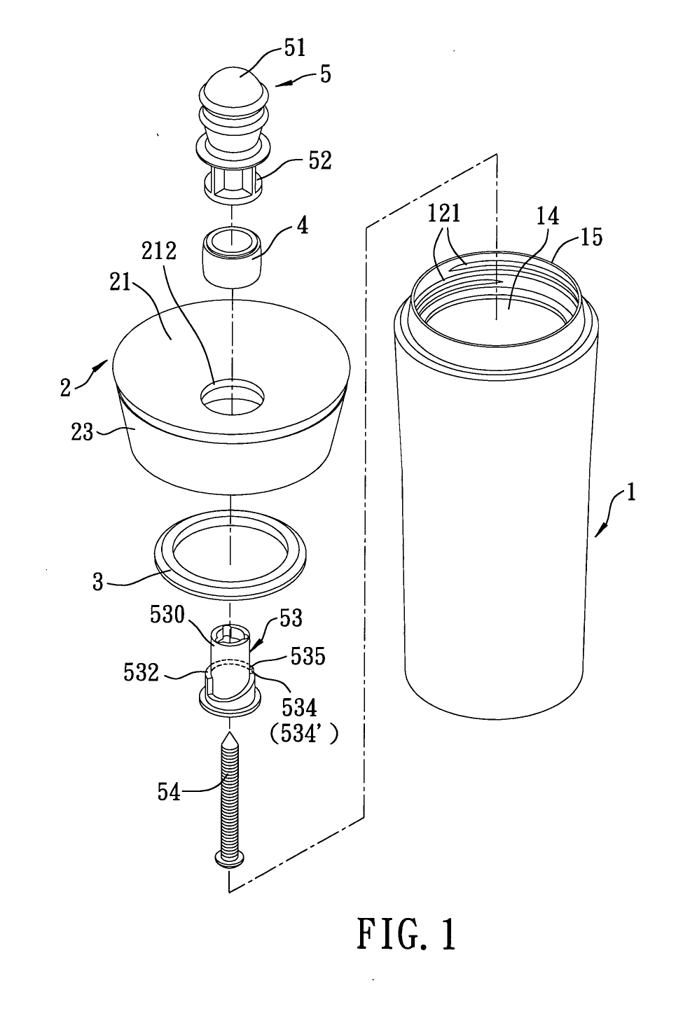

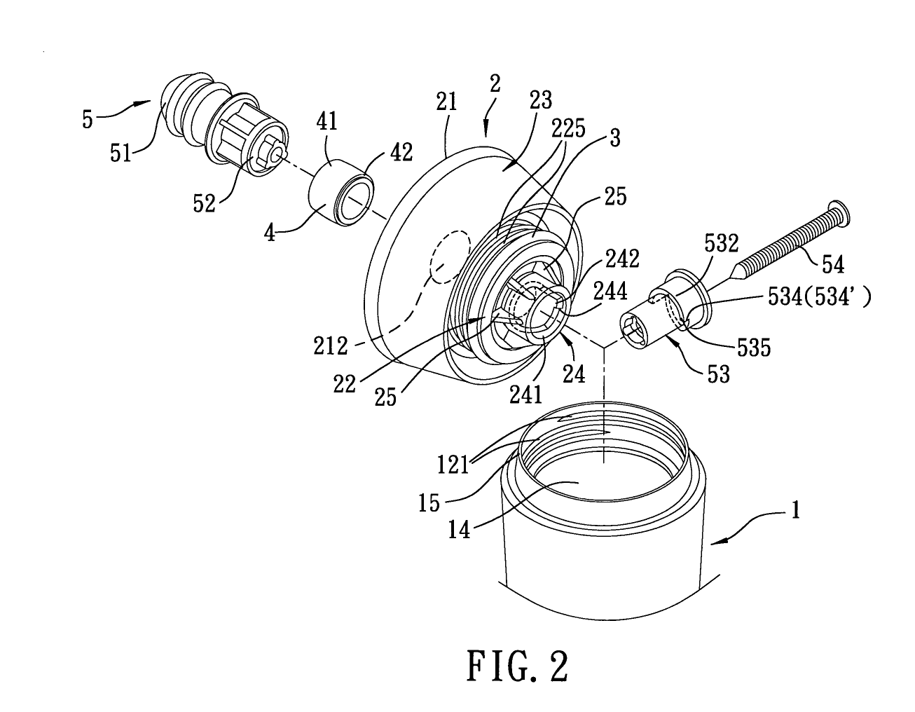

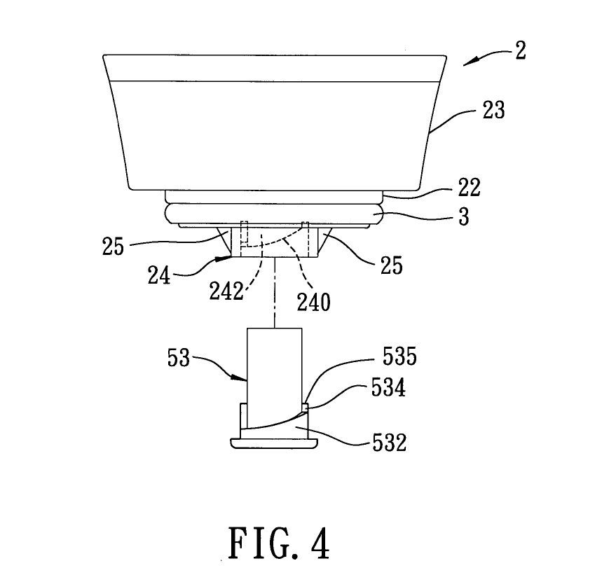

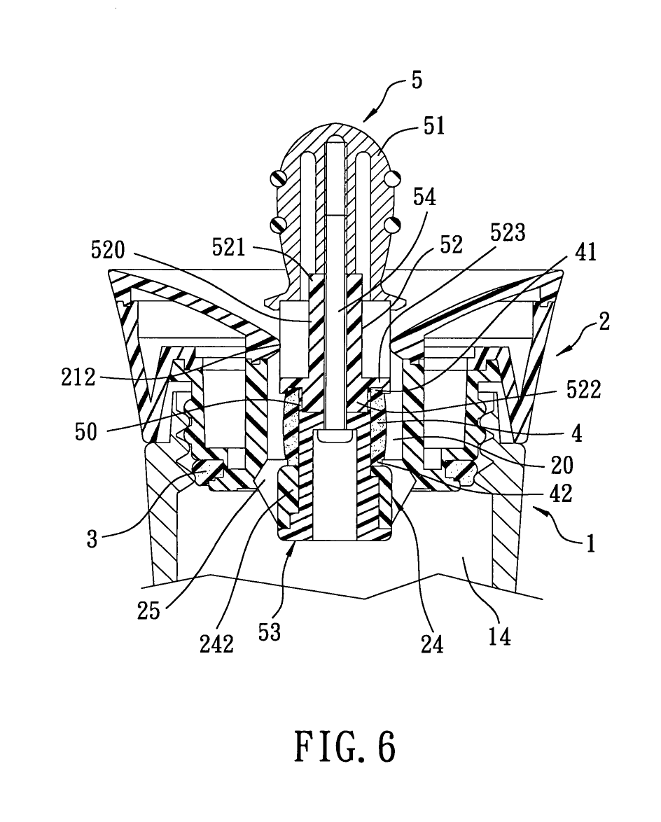

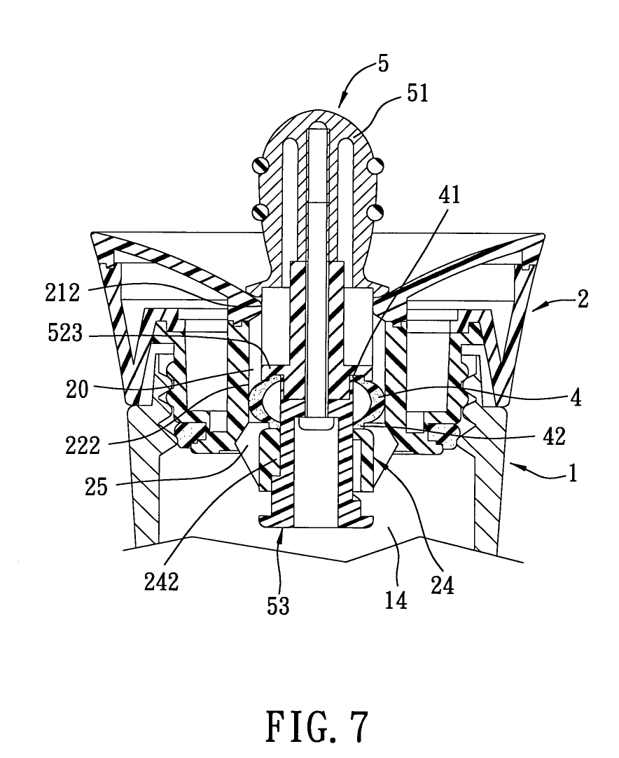

Referring to FIGS. 1 to 6, the preferred embodiment of a cylindrical container according to the present invention is shown to include: a cylindrical container body 1 defining an inner space 14 and having a top open end 15; a cap 2 mounted securely on the top open end 15 of the container body 1 and including an annular inner wall 22 having an inner surface 222 that defines a fluid passage 20 for fluid communication with the inner space 14, and a seat 24 secured to the annular inner wall 22 and extending into the fluid passage 20; a valve including a deformable sealing member 4 disposed in the fluid passage 20 and disposed above and seated on the seat 24; and an operating unit 5 including a handle 51 that is disposed on an exterior of the cap 2, and a pressing member 52 that is coupled to the handle 51, that is disposed in the fluid passage 20, and that is disposed above and that abuts against the deformable sealing member 4. The operating unit 5 is operable to move axially relative to the cap 2 between first and second axial positions (see FIGS. 6 and 7). The sealing member 4 is deformable radially so as to be deformed (see FIG. 7) to contact sealingly the inner surface 222 of the annular inner wall 22 by pressing action of the pressing member 52 when the operating unit 5 is moved from the first axial position to the second axial position.

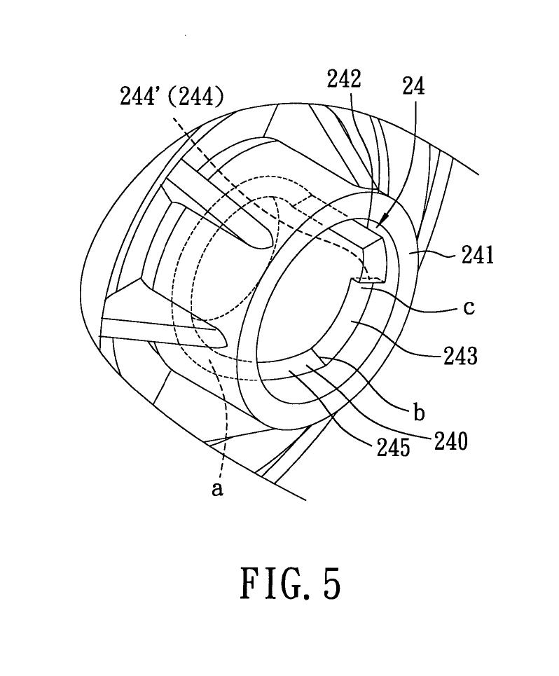

The seat 24 includes a tubular supporting member 241 formed with a first shoulder 242 extending inwardly there from and defining a cam face 240 (see FIG. 5) facing axially and having a helically extending section 245. The operating unit 5 further includes a tubular driving member 53 that extends through the tubular supporting member 241, that is secured to the pressing member 52 and the handle 51, and that is formed with a second shoulder 532 extending outwardly therefrom and having a driving face 535 facing axially and in sliding contact with the helically extending section 245 of the cam face 240 such that rotation of the handle 51 together with the pressing member 52 and the tubular driving member 53 relative to the cap 2 results in axial movement of the operating unit 5 relative to the cap 2.

The cam face 240 further has a laterally extending section 243 radiating inwardly from the tubular supporting member 241, extending from the helically extending section 245, and having a stopping end that is distal from the helically extending section 245. Moreover, the first shoulder 242 of the tubular supporting member 241 is formed with a first step 244′ that extends axially and downwardly from the stopping end of the laterally extending section 243 of the cam face 240 and that defines a first stopper 244. The driving face 535 of the second shoulder 532 radiates outwardly from the tubular driving member 53. The second shoulder 532 of the tubular driving member 53 is formed with a second step 534′ that extends axially and downwardly from an edge of the driving face 535 and that defines a second stopper 534. The second stopper 534 abuts against the first stopper 244, and the driving face 535 is in sliding contact with the laterally extending section 243 of the cam face 240 when the operating unit 5 is disposed at the second axial position.

The sealing member 4 is made from silicone rubber, is tubular in shape, and has upper and lower ends 41, 42. The pressing member 52 has a tubular part 520 that has an upper end portion 521 connected to the handle 51 and a lower end portion 522 extending into the sealing member 4, and a flange 523 that extends radially from the tubular part 520 and that abuts against the upper end 41 of the sealing member 4.

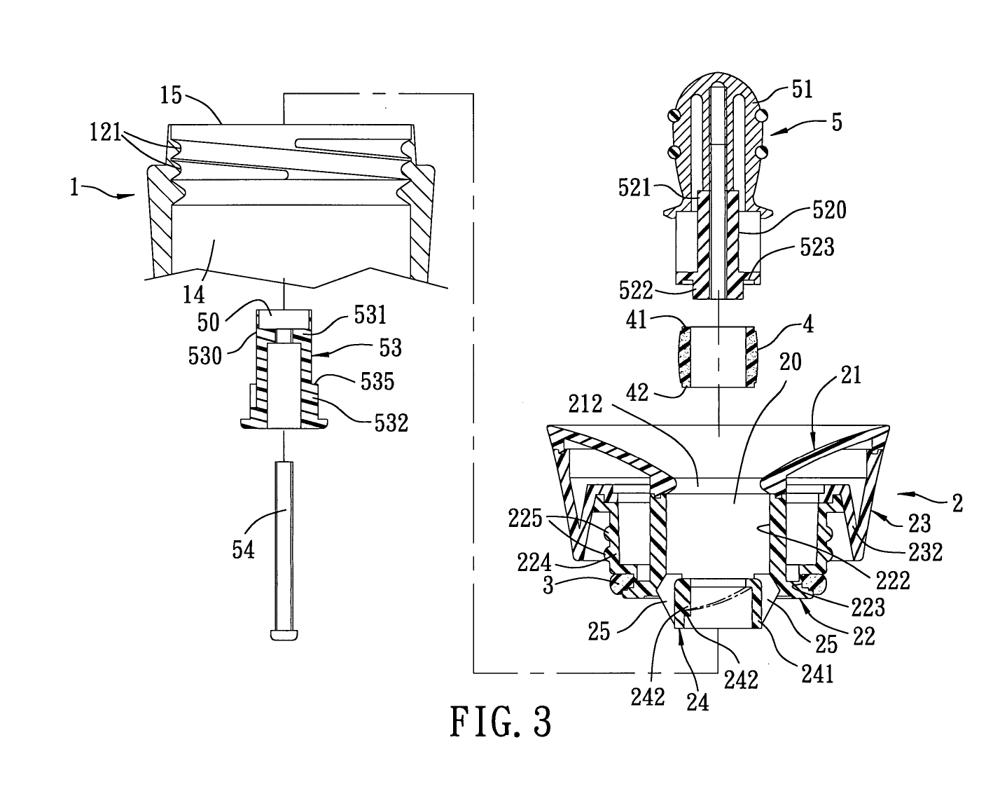

The tubular driving member 53 has an upper end portion 530 (see FIG. 3) extending into the sealing member 4, defining a top recess 50 receiving the lower end portion 522 of the tubular part 520 of the pressing member 52 therein and defined by a recess-defining wall 531 that is in contact with the lower end portion 522 of the tubular part 520 of the pressing member 52. The container further includes a screw bolt 54 extending through the recess-defining wall 531 of the driving member 531 and the tubular part 520 of the pressing member 52 to engage threadedly the handle 51.

The cap 2 further includes a plurality of annularly displaced connecting plates 25 disposed between and interconnecting the annular inner wall 22 and the seat 24, an annular outer wall 23 surrounding the annular inner wall 22, and a funnel-shaped top wall 21 interconnecting the annular inner and outer walls 22, 23 and defining a central opening 212 that is in fluid communication with the fluid passage 20. The tubular part 520 of the pressing member 52 extends through the central opening 212 in the funnel-shaped top wall 21. The cap 2 further includes an annular middle wall 224 that is disposed between and that is connected to the annular inner and outer walls 22, 23, and that is formed with an outer thread 225. The container body 1 is formed with an inner thread 121 that engages threadedly the outer thread 225 of the annular middle wall 224.

The annular middle wall 224 of the cap 2 is further formed with an annular retaining groove 223. The container further includes a sealing ring 3 that is received in the annular retaining grove 223 and that is in sealing contact with the container body 1 and the annular middle wall 224 of the cap 2. In this embodiment, the sealing ring 3 is an o-ring used for preventing liquid from leaking out of the inner space 14.

Referring to FIG. 5, in combination with FIGS. 6 and 7, when the handle 51 of the operating unit 5 is rotated clockwise, the driving face 535 slides from a starting point (a) to an end point (b) on the helically extending section 245 of the cam face 240, which results in axial movement of the operating unit 5 from the first axial position to the second axial position. Further clockwise rotation of the handle 51 results in sliding movement of the driving face 535 along the laterally extending section 243 of the cam face 240 from the end point (b) to the stopping point (c) on the laterally extending section 243 and abutment between the first and second stoppers 244, 534.

To restore the sealing member 4, the operating unit 5 is rotated counterclockwise so as to permit axial movement of the operating unit 5 from the second axial position to the first axial position by virtue of the resilient force of the sealing member 4.

The container of this invention is advantageous in that the opening and closing mechanism of the valve is relatively simple.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A container comprising:
a container body defining an inner space and having a top open end;
a cap mounted securely on said top open end of said container body and including
an annular inner wall having an inner surface that defines a fluid passage for fluid communication with said inner space, and
a seat secured to said annular inner wall and extending into said fluid passage;
a valve including a sealing member disposed in said fluid passage and disposed above and seated on said seat; and
an operating unit including a handle that is disposed on an exterior of said cap, and a pressing member that is coupled to said handle, that is disposed in said fluid passage, and that is disposed above and that abuts against said sealing member;
wherein said operating unit is operable to move axially relative to said cap between first and second axial positions; and
wherein said sealing member is deformable so as to be deformed to contact sealingly said inner surface of said annular inner wall by pressing action of said pressing member when said operating unit is moved from said first axial position to said second axial position.

2. The container as claimed in claim 1, wherein said seat includes a tubular supporting member formed with a first shoulder extending inwardly therefrom and defining a cam face that faces axially and that has a helically extending section, said operating unit further including a tubular driving member that extends through said tubular supporting member, that is secured to said pressing member and said handle, and that is formed with a second shoulder extending outwardly therefrom and having a driving face that faces axially and that is in sliding contact with said helically extending section of said cam face such that rotation of said handle together with said pressing member and said tubular driving member relative to said cap results in axial movement of said operating unit relative to said cap.

3. The container as claimed in claim 2, wherein said cam face of said first shoulder of said tubular supporting member further has a laterally extending section that radiates inwardly from said tubular supporting member, that extends from said helically extending section, and that has a stopping end distal from said helically extending section, said first shoulder of said tubular supporting member being formed with a first step that extends axially and downwardly from said stopping end of said laterally extending section of said cam face, and that defines a first stopper, said driving face radiating outwardly from said tubular driving member, said second shoulder of said tubular driving member being formed with a second step that extends axially and downwardly from an edge of said driving face and that defines a second stopper, said second stopper abutting against said first stopper and said driving face being in sliding contact with said laterally extending section of said cam face when said operating unit is disposed at said second axial position.

4. The container as claimed in claim 2, wherein said sealing member is tubular in shape, and has upper and lower ends, said pressing member having a tubular part that has an upper end portion connected to said handle and a lower end portion extending into said sealing member, and a flange that extends radially from said tubular part and that abuts against said upper end of said sealing member.

5. The container as claimed in claim 4, wherein said tubular driving member has an upper end portion extending into said sealing member and defining a top recess receiving said lower end portion of said pressing member therein and defined by a recess-defining wall that is in contact with said lower end portion of said tubular part of said pressing member, said container further comprising a screw bolt extending through said recess-defining wall of said upper end portion of said driving member and said tubular part of said pressing member to engage threadedly said handle.

6. The container as claimed in claim 2, wherein said cap further includes a plurality of annularly displaced connecting plates disposed between and interconnecting said annular inner wall and said seat.

7. The container as claimed in claim 6, wherein said cap further includes an annular outer wall surrounding said annular inner wall, and a funnel-shaped top wall interconnecting said annular inner and outer walls and defining a central opening that is in fluid communication with said fluid passage, said tubular part of said pressing member extending through said central opening in said funnel-shaped top wall.

8. The container as claimed in claim 7, wherein said cap further includes an annular middle wall that is disposed between and that is connected to said annular inner and outer walls, and that is formed with an outer thread, said container body being formed with an inner thread that engages threadedly said outer thread of said annular middle wall.

9. The container as claimed in claim 8, wherein said annular middle wall of said cap is formed with an annular retaining groove, said container further comprising a sealing ring received in said annular retaining grove and in sealing contact with said container body and said annular middle wall of said cap.
